(19) United States
(12) Patent Application Publication
(10) Pub. No.: US 2020/0095757 A1
(43) Pub. Date: Mar. 26, 2020

(54) ASSISTIVE APPARATUS WITH ADJUSTABLE SEAT HEIGHT

(71) Applicant: Brian Schwab, Each Chatham, NY (US)

(72) Inventors: Brian Schwab, Each Chatham, NY (US); Cheng-Yang Lai, Taipei City (TW)

(73) Assignee: Brian Schwab, Each Chatham, NY (US)

(21) Appl. No.: 16/581,748

(22) Filed: Sep. 24, 2019

Related U.S. Application Data
(60) Provisional application No. 62/736,633, filed on Sep. 26, 2018.

(51) Int. Cl. E03D 11/12; A61G 7/10; A47K 13/28

(52) U.S. Cl. CPC E03D 11/125; A47K 2017/006; A47K 13/28; A61G 7/1007

(57) ABSTRACT

An assistive apparatus with adjustable height is designed to be placed on or about a toilet such that when an individual uses the toilet the weight of the individual is transferred to the assistive apparatus and not directly on the toilet, avoiding distribution of heavy weight to the toilet itself. The invention also includes a powered lifting mechanism to aid the individual in utilizing a toilet. The powered lifting mechanism includes a pair of lift arm assemblies which are driven by a motor at both sides to raise and lower the assistive platform and be tilted between a first stationery position and a second tilted position, tilted at an angle (“a”) in a vertical “Z” direction from a horizontal plane. The front and back supporting legs are used to provide sturdy structural support for a person's weight whiling sitting on the assistive apparatus atop of a toilet.

### BACKGROUND OF THE INVENTION

Embodiments of the present invention generally relate to an assistive apparatus with adjustable seat height to be used in conjunction with a toilet seat.

### Description of the Related Art

Conventionally, the size and shape of a toilet seat are fixed without the capacity to adjust the height of the toilet seat as desired or customized per individual use. People with specific needs, such as bariatric, disable, and senior persons, who may have difficulty in sitting down and/or getting up and may need assistance.

Therefore, an assistive apparatus is desirable to be adapted on or about a toilet seat so as to adjust height and assist a person while using the toilet.

### SUMMARY OF THE INVENTION

The invention generally provides an assistive apparatus and a method of using the assistive apparatus. The assistive apparatus includes an assistive platform having a centered opening, a supporting leg assembly comprising one or more front supporting legs connected to the assistive platform, and a lifting assembly connected to the assistive platform and adapted to lift the assistive platform. In one embodiment, the lifting assembly includes one or more lifting shafts adapted to lift the assistive platform so as to position the assistive platform tilted between a first stationery position and a second tilted position, tilted at an angle (“α”) in a vertical “Z” direction from a horizontal plane. In one aspect, the “α” angle is adjusted to be between 0° and 80°.

In one aspect, the one or more front supporting legs are substantially vertical and physically connected to one or more floor mounting flanges to secure the assistive apparatus and prevent movement. In another aspect, the one or more front supporting legs are connected to a front bar via one or more connectors. In addition, the lifting assembly may include one or more ball screw linear actuators and one or more nuts connected to the one or more lifting shafts.

In another aspect, the assistive apparatus further includes a buttock-spreading mechanism having one or more actuators being positioned within a leaflet support housing, a right leaflet being positioned on a top side of the assistive platform and connected to the one or more actuators within the leaflet support housing, and a left leaflet being positioned on the top side of the assistive platform and connected to the one or more actuators within the leaflet support housing. In one embodiment, the one or more actuators are adapted to adjust a horizontal distance (“H”) between the left leaflet and the right leaflet, wherein the horizontal distance (“H”) is adjustable between a first horizontal distance (“H₁”) and a second horizontal distance (“H₂”). In one example, the one or more actuators are ball screw linear actuators.

In another embodiment, the one or more actuators are connected to one or more drive mechanisms and adapted to be rotated counterclockwise so as to move the right leaflet and the left leaflet in a direction L₁, and be rotated clockwise so as to move the right leaflet and the left leaflet in a direction L₂. The assistive apparatus may further include a support frame mounting base adapted to be secured to a toilet assembly. The support frame mounting base are connected to one or more back supporting legs.

In still another embodiment, the one or more back supporting legs are substantially vertical and physically connected to one or more floor mounting flanges to secure the assistive apparatus and prevent movement. Further, the assistive apparatus may include a backrest assembly having a backrest pad, a top support frame connected to the backrest pad, a bottom support frame connected to the top support frame with one or more adjustable knobs, and a support frame mounting base connected to the bottom support frame.

A method of using the assistive apparatus includes a user getting seated on top of an assistive apparatus on or about a toilet seat and press a “Down” button on a controller to lower the assistive platform of the assistive apparatus to be close to the toilet seat; and once seated, the user can press any of “Expand”, “Retract”, “Tilted”, “Up” and/or “Down” buttons on the controller to adjust seat height of the assistive platform or the size of the and accommodate the dimensions of the user's buttocks. The method may further include, after using the toilet toileting is finished, the user can press the “UP” button on the controller to restore a right leaflet and a left leaflet to the original position and then lift the assistive platform up to assist the user in getting up from the toilet.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of one example of an assistive toilet seat apparatus with adjustable seat height and a toilet according to an embodiment of the invention shown in an elevated state (at an angle of “α”).

FIG. 2 is a perspective view of another example of an assistive toilet seat apparatus with adjustable seat height and a toilet according to one embodiment of the invention shown in a flat state.

FIG. 3 is a perspective view of one example of a powered lifting mechanism according to one embodiment of the invention shown in a flat state.

FIG. 4 is a side view of another example of a powered lifting mechanism according to another embodiment of the invention shown in an elevated state (at an angle of “α”).

FIG. 5 is a side view of still another example of a powered lifting mechanism according to still another embodiment of the invention in a flat state.

FIG. 6 is a top view of one example of a buttock spreading mechanism on an assistive platform according to another embodiment of the invention.

FIG. 7 is a side view of one example of a supporting leg mechanism according to another embodiment of the invention in a flat state.

FIG. 8 is a perspective view of one example of operating a buttock spreading mechanism to expand the right leaflet and the left leaflet according to still another embodiment of the invention at the horizontal distance (“H₁”).

FIG. 9 is a perspective view of another example of operating a buttock spreading mechanism to retract the right leaflet and the left leaflet according to another embodiment of the invention at the horizontal distance (“H₂”).

FIG. 10 is a front view of still another example of a supporting leg mechanism according to yet another embodiment of the invention.

FIG. 11 is a front view of one example of an assistive toilet seat apparatus with adjustable back rest height according to yet another embodiment of the invention.

### DETAILED DESCRIPTION

The present invention includes an assistive apparatus for providing a mechanism of adjusting seat height while using a toilet. The assistive apparatus can be placed directly over a rim of a toilet bowl, a seat of a toilet seat system or a bedside commode.

Therefore, the invention includes a powered lifting mechanism to aid the individual in utilizing a toilet. The powered lifting mechanism includes a pair of lift arm assembly which are driven by a motor at both sides, which raises and lowers the assistive platform. The front and back supporting legs provide support to the assistive platform keeping the toilet from user's weight

The assistive toilet seat apparatus with a powered lifting mechanism includes is designed to be placed on a toilet such that when an individual uses the toilet the seat could be lifted up or lifted down

The assistive apparatus with a lifting assembly as described in detail below is capable of lifting the assistive platform so as to position the assistive platform to be tilted between a first stationery position to a second tilted position, tiled horizontally at an angle (“α”). In one aspect, the “α” angle is adjusted to be between 0° and 80°. In another aspect, the lifting assembly further includes one or more ball screw linear actuators, and one or more nuts connected to the one or more lifting shafts. In addition, the assistive apparatus equipped with a lifting assembly with is designed to be placed on any kinds of a toilet, any shower chairs, or other devices such that when a person uses the toilet the setting apparatus could be lifted up or lifted down.

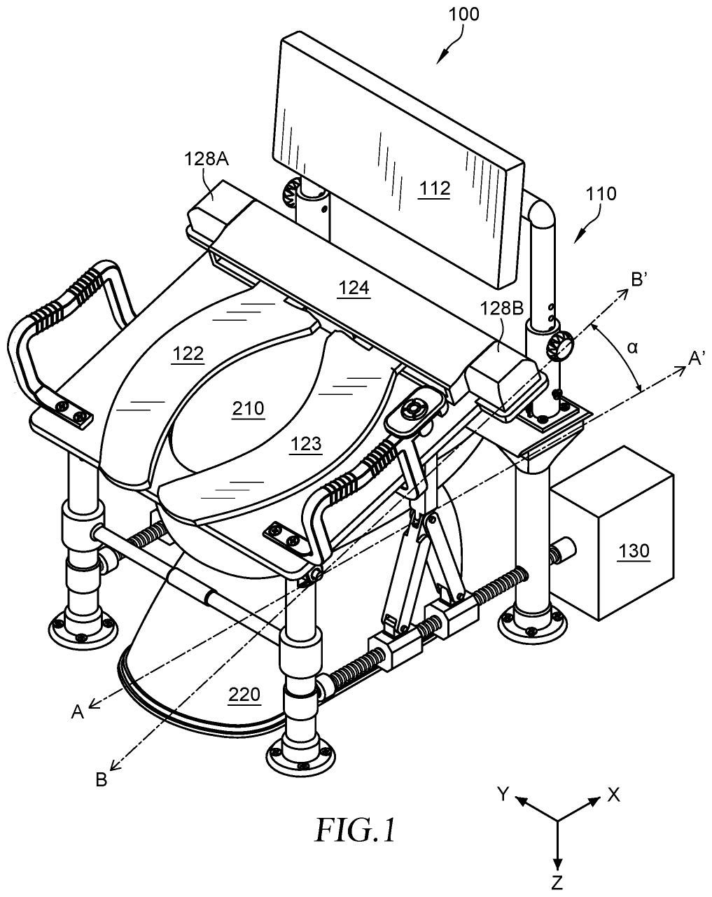

FIG. 1 illustrates one embodiment of an assistive apparatus 100 in an elevated state, which generally includes right leaflet 122, left leaflet 123, leaflet support base 124, and two drive mechanisms 128A & 128B. The assistive apparatus 100 is positioned in an elevated state and attached to a conventional toilet bowl 210, commonly found in residential, commercial, and institutional environments. A power unit 130, containing internal electric and a motor is located to the lower rear area of the toilet base 220. Electric power of this device is routed from the power unit 30. The assistive apparatus 100 tilts at an angle of a.

In one embodiment, the assistive apparatus includes a lifting assembly being connected to the assistive platform, where the lifting assembly incudes one or more lifting shafts adapted to lift the assistive platform so as to position the assistive platform to be tilted between a first stationery position to a second tilted position, tiled horizontally at an angle (“α”). In one aspect, the “α” angle is adjusted to be between 0° and 80°. In another aspect, the lifting assembly further includes one or more ball screw linear actuators, and one or more nuts connected to the one or more lifting shafts

In a further embodiment, the one or more actuators are connected to one or more drive mechanisms and adapted to be rotated counterclockwise so as to move the right leaflet and the left leaflet in a direction L₁, and be rotated clockwise so as to move the right leaflet and the left leaflet in a direction L₂. In another embodiment, the one or more actuators comprises one or more ball screw linear actuators.

In still another embodiment, the assistive apparatus further includes one or more front supporting legs connected to the assistive platform. In one aspect, the one or more front supporting legs are substantially vertical and physically connected to one or more floor mounting flanges to secure the assistive apparatus and prevent movement. In another aspect, the one or more front supporting legs are connected to a front bar via one or more connectors.

In yet another embodiment, the assistive apparatus further includes one or more back supporting legs, being connected to a support frame mounting base and not connected to the assistive platform, where the support frame mounting base is adapted to support the assistive platform. In one aspect, the one or more back supporting legs are substantially vertical and physically connected to one or more floor mounting flanges to secure the assistive apparatus and prevent movement.

In another embodiment, the assistive apparatus further includes a controller being adapted to control the one or more actuators to adjust the horizontal distance (“H”) between the left leaflet and the right leaflet move the right. In one aspect, the controller is clipped on one or more grab handles, where the one or more grab handles are connected to the assistive platform and adapted to provide support to a person while the person is using the assistive apparatus. In another aspect, the controller includes a charging slot for charging the controller.

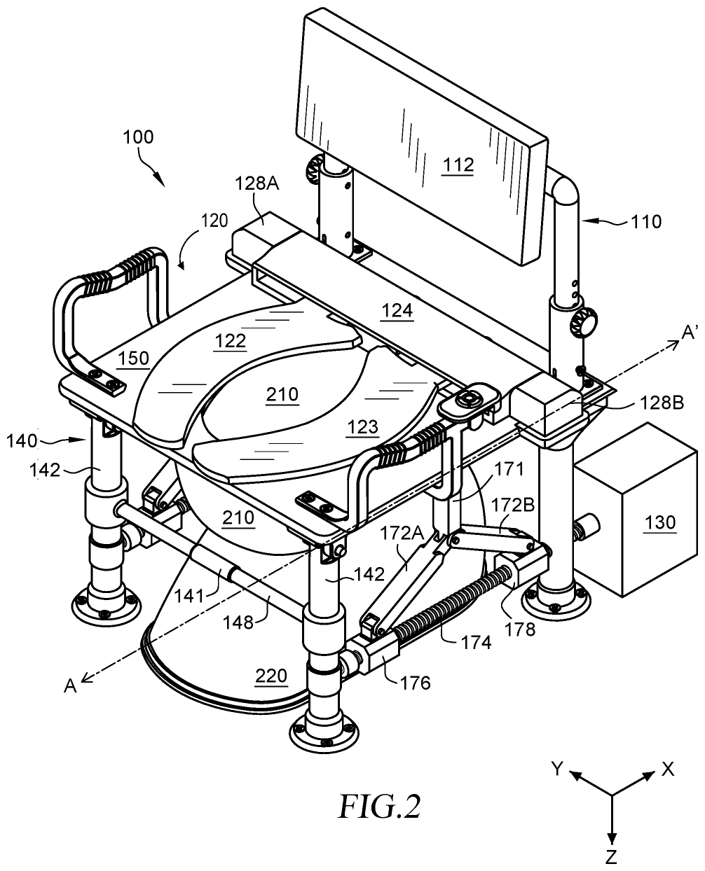

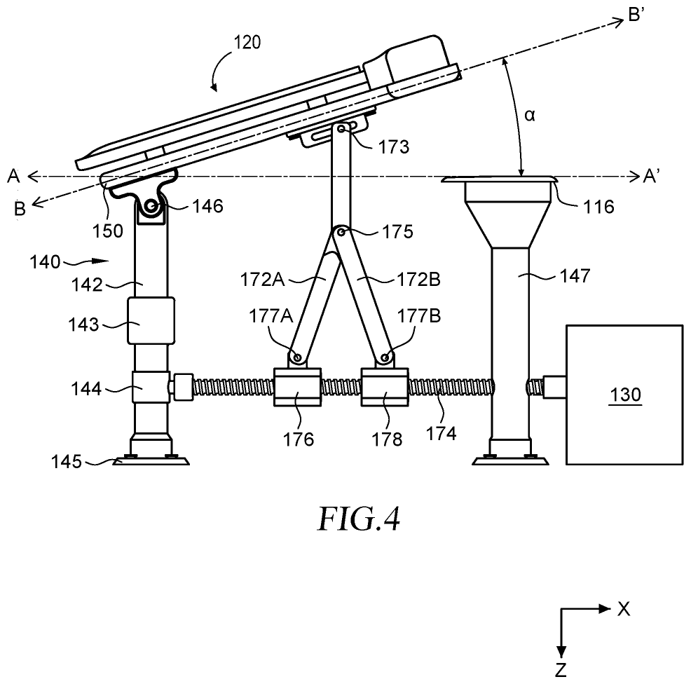

FIG. 2 is one example of the assistive toilet seat apparatus with adjustable seat height being positioned in a flat state and secured on a toilet bowl 210 according to one embodiment of the invention. On the rear side of the assistive toilet seat apparatus 100, there is a back rest pad 112 which serves as a back support. An assistive platform 150 is supported by a supporting leg mechanism 140 and a lifting mechanism 170 on the both sides. The supporting leg mechanism 140 comprises two front supporting legs 142 and two back supporting legs 147 (see FIG.4). Each front supporting leg 142 is preferably substantially vertical. The two front supporting legs 142 are connected by a frame connector 141 and a front bar 148 to ensure a stable foundation.

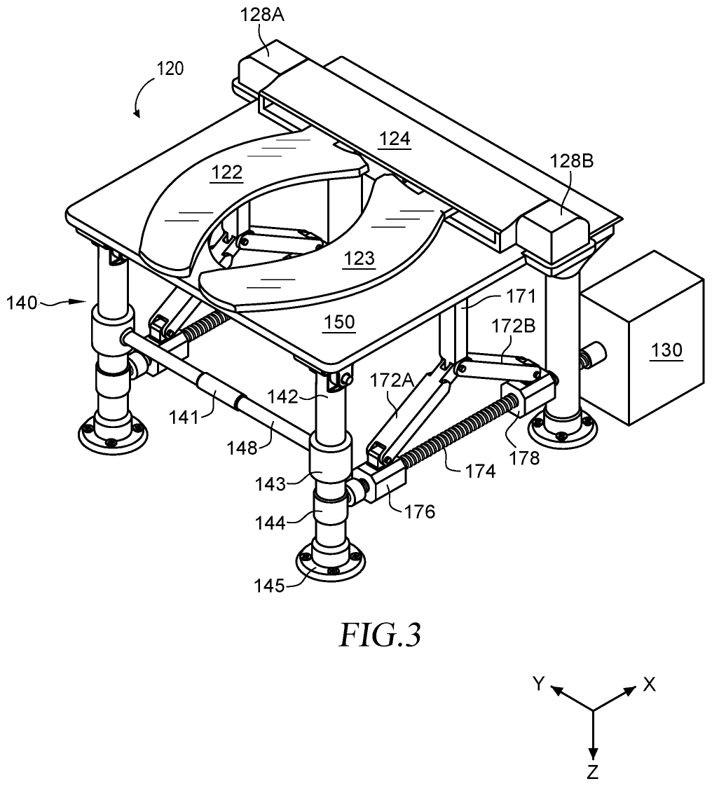

FIG. 3 is a perspective view of the lifting mechanism 170, showing in a flat state. The lifting mechanism 170 comprising supporting shaft 171, supporting shaft 172A & 172B, ball screw linear actuator 174 driven by the power unit 130, and two nuts 176 & 178. To ensure a stable foundation, the ball screw linear actuator 174 connects to the front supporting leg 142 via a connector 144, and the front bar 148 connects to the front supporting leg 142 via a connector 143 on the both sides. Each front supporting leg 142 is physically joined to a floor mounting flange 145. The floor mounting flange 145 is secured with four floor mounting bolts to prevent movement.

FIG. 4 illustrates a method of operating the lifting mechanism 170 according to one or more embodiments of the invention. As shown in FIG. 4, to lift up the assistive platform 150, the power unit 130 rotates the ball screw linear actuator 174 to move the nuts 176 & 178 from the sides to the center. The top side of the supporting shaft 172 A & 172B will push each other so the top supporting shaft 171 will move higher which generate an upward force to lift up the assistive platform from a support frame mounting base 116 so that it can tilt forward from a direction “A” to a direction “B” with a hinge 146. The tilt angle between the direction “A” and the direction “B” is “α”. The supporting shafts 172A & 172B are connected with the nuts 176 & 178 by two binding screws 177A & 177B. Also, the supporting shaft 171 connects to the assistive platform 150 with a binding screw 173. The supporting shafts 171 & 172 are assembled with a binding screw 175.

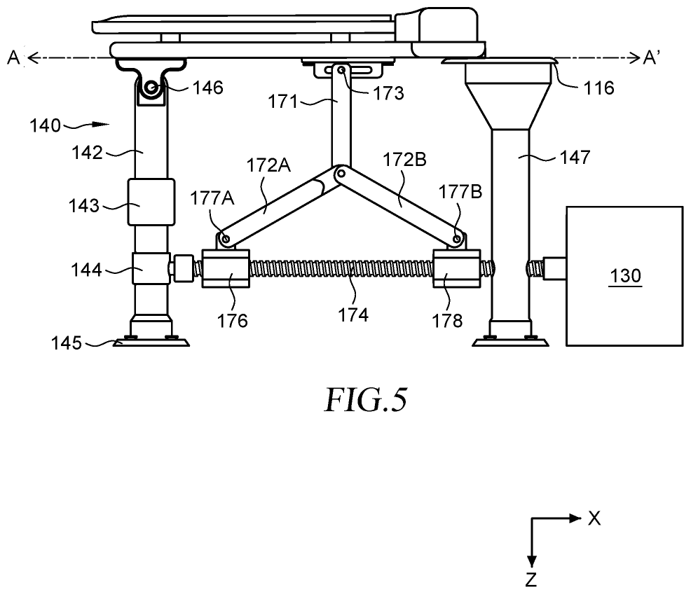

FIG. 5 illustrates a method of operating the lifting mechanism 170 according to one or more embodiments of the invention. As shown in FIG. 4, to lift up the assistive platform 150, the power unit 130 rotates the ball screw linear actuator 174 to move the nuts 176 & 178 from the sides to the center. The top side of the supporting shaft 172A & 172B will push each other so the top supporting shaft 171 will move higher which generate an upward force to lift up the assistive platform from a support frame mounting base 116 so that it can tilt forward from a direction “A” to a direction “B” with a hinge 146. The tilt angle between the direction “A” and the direction “B” is “α”. The supporting shafts 172 A & 172B are connected with the nuts 176 & 178 by two binding screws 177A & 177B. Also, the supporting shaft 171 connects to the assistive platform 150 with a binding screw 173. The supporting shafts 171 & 172 are assembled with a binding screw 175.

As shown in FIG. 5, the assistive platform 150 of the invention can be kept flat on the support frame mounting base 116 which is supported by a back supporting leg 147. To lower the assistive platform 150 back to flat level, the power unit 130 rotates the ball screw linear actuator 174 to move the nuts 176 & 178 from the center to the sides. The bottom side of the supporting shaft 172A & 172B will pull each other so the top supporting shaft 171 will move lower which generate a downward force to lower the assistive platform

As shown in FIG. 1, during the operation of the lifting mechanism by a user, the assistive platform 150 can tilt forward in a direction “B” by a user to a desirable height at an angle of “α”. Accordingly, the user is able to adjust the position of the assistive platform 150 for easily getting up from the assistive apparatus 100.

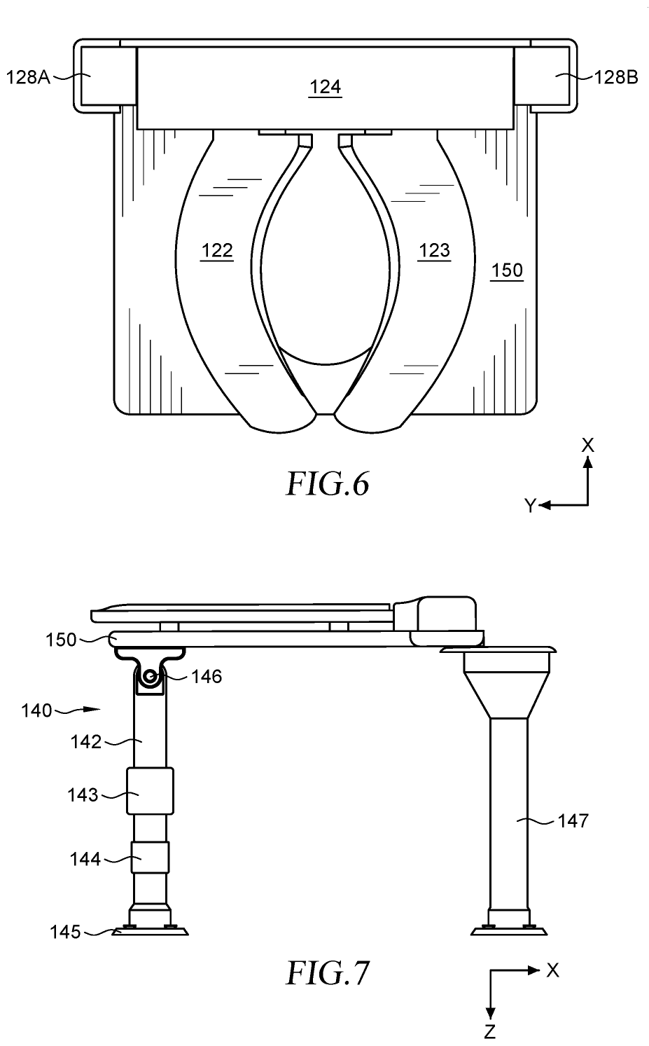

FIG. 6 shows a top view of a right leaflet and a left leaflet 122 & 123, two drive mechanisms 128, a leaflet support base 124 and an assistive platform 150 according to another embodiment of the invention shown in a retracted state

FIG. 7 illustrate a side view of the supporting mechanism 140 in a flat state. As shown in FIG.7, the assistive platform 150 can be supported by only the front supporting legs 142 and the back supporting legs 147.

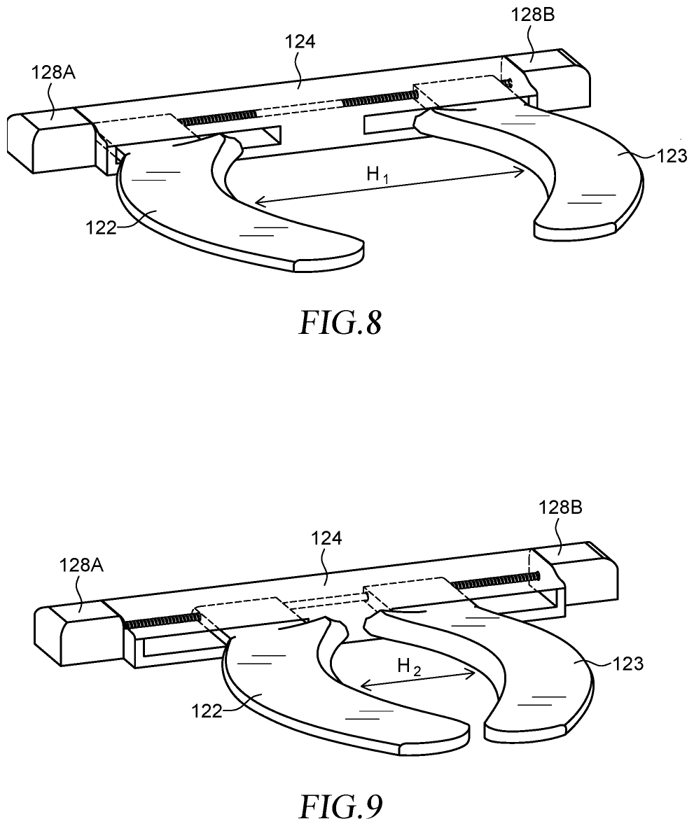

FIG. 8 illustrate a method of operating the assistive apparatus 100 according to one or more embodiments of the invention. As shown in FIG. 8, the right leaflet 122 and left leaflet 123 of the invention can be positioned to the two sides of the leaflet support base 124 by the drive mechanisms 128A & 128B with a distance H₁. As shown in FIG. 9, the right leaflet 122 and left leaflet 123 of the invention can be positioned to the center of the leaflet support base 124 by the drive mechanisms 128A & 128B with a distance H₂.

FIG. 9 illustrate a method of operating the assistive apparatus 100 according to one or more embodiments of the invention. As shown in FIG. 8, the right leaflet 122 and left leaflet 123 of the invention can be positioned to the two sides of the leaflet support base 124 by the drive mechanisms 128A & 128B with a distance H₁. As shown in FIG. 9, the right leaflet 122 and left leaflet 123 of the invention can be positioned to the center of the leaflet support base 124 by the drive mechanisms 128A & 128B with a distance H₂.

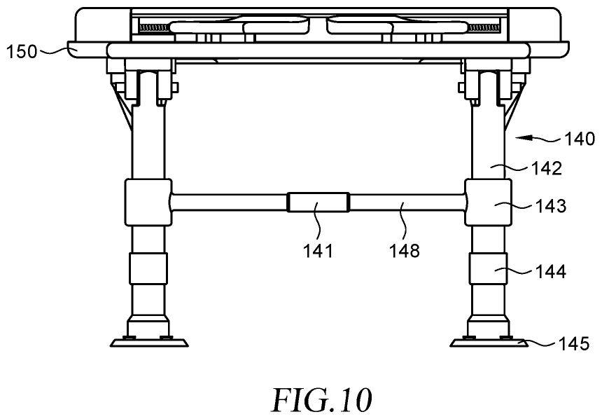

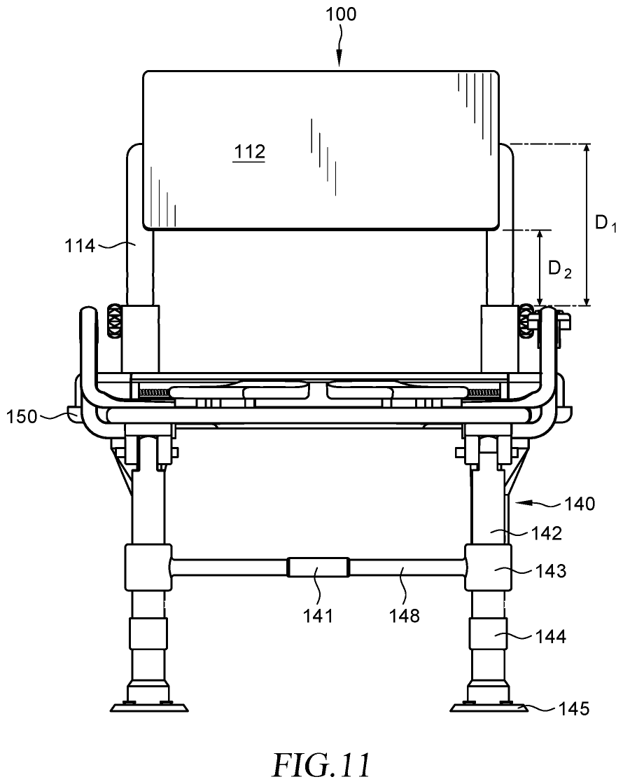

FIG. 10 is a front view of the assistive platform 150 and the supporting mechanism 140 is shown. FIG. 11 shows a front view of the assistive apparatus 100 in a flat state. As shown in FIG. 11, the vertical position of the back rest pad 112 is adjustable by moving a top supporting frame which the back rest pad is attached on. A distance “D₁” shows the highest height that the top supporting frame can be adjusted, and a Distance “D₂” shows the lowest height that the top supporting frame can be adjusted.

1. An assistive apparatus, comprising:
an assistive platform having a centered opening;
a supporting leg assembly comprising one or more front supporting legs connected to the assistive platform; and
one or more lifting assemblies connected to the assistive platform and adapted to lift the assistive platform, wherein each of the lifting assemblies comprises one or more lifting shafts adapted to lift the assistive platform so as to position the assistive platform tilted between a first stationery position and a second tilted position, tilted at an angle (“α”) in a vertical “Z” direction from a horizontal plane.

2. The assistive apparatus of claim 1, wherein the “α” angle is adjusted to be between 0° and 80°.

3. The assistive apparatus of claim 1, wherein each of the lifting assembly further comprises:
one or more ball screw linear actuators; and
one or more nuts connected to the one or more lifting shafts.

4. The assistive apparatus of claim 3, wherein the lifting assembly are connected to one or more power units adapted to drive the one or more ball screw linear actuators.

5. The assistive apparatus of claim 1, wherein the one or more front supporting legs are substantially vertical and physically connected to one or more floor mounting flanges to secure the assistive apparatus and prevent movement.

6. The assistive apparatus of claim 1, wherein the one or more front supporting legs are connected to a front bar via one or more connectors.

7. The assistive apparatus of claim 1, further comprising:
a buttock-spreading mechanism comprising:
one or more actuators being positioned within a leaflet support housing;
a right leaflet being positioned on a top side of the assistive platform and connected to the one or more actuators within the leaflet support housing; and
a left leaflet being positioned on the top side of the assistive platform and connected to the one or more actuators within the leaflet support housing, wherein the one or more actuators are adapted to adjust a horizontal distance (“H”) between the left leaflet and the right leaflet, wherein the horizontal distance (“H”) is adjustable between a first horizontal distance (“H₁’) and a second horizontal distance (“H₂”).

8. The assistive apparatus of claim 7, wherein the one or more actuators comprises one or more ball screw linear actuators.

9. The assistive apparatus of claim 7, wherein the one or more actuators are connected to one or more drive mechanisms and adapted to be rotated counterclockwise so as to move the right leaflet and the left leaflet in a direction L₁, and be rotated clockwise so as to move the right leaflet and the left leaflet in a direction L₂.

10. The assistive apparatus of claim 1, further comprising:
a support frame mounting base adapted to be secured to a toilet assembly.

11. The assistive apparatus of claim 10, wherein the support frame mounting base are connected to one or more back supporting legs.

12. The assistive apparatus of claim 11, wherein the one or more back supporting legs are substantially vertical and physically connected to one or more floor mounting flanges to secure the assistive apparatus and prevent movement.

13. The assistive apparatus of claim 1, further comprising:
a backrest assembly comprising:
a backrest pad;
a top support frame connected to the backrest pad;
a bottom support frame connected to the top support frame with one or more adjustable knobs; and
a support frame mounting base connected to the bottom support frame.
